(19) United States
(12) Patent Application Publication
(10) Pub. No.: US 2007/0130435 A1
(43) Pub. Date: Jun. 7, 2007

(54) Terminal apparatus and its data management method

(75) Inventor: Takami Sugita, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/543,147

(22) Filed: Oct. 5, 2006

(30) Foreign Application Priority Data
Dec. 7, 2005 (JP) 2005-353734

(51) Int. Cl. G06F 12/14

(52) U.S. Cl. 711/163

(57) ABSTRACT

A terminal apparatus is provided with a memory, a communication section, an authentication section configured to execute authentication when a signal requesting access to the memory is received, a save processing section configured to save predetermined data of the memory in a predetermined storage section when the authentication section outputs a negative result, and an erasing section configured to erase the predetermined data from the memory after the predetermined data is saved.

### CROSS-REFERENCE TO RELATED APPLICATIONS

This application is based upon and claims the benefit of priority from Japanese Patent Application No. 2005-353734, filed Dec. 7, 2005, the entire contents of which are incorporated herein by reference.

### BACKGROUND

1. Field

The invention relates to a terminal apparatus and a data management method it uses. More specifically, the invention is advantageously applied to a terminal apparatus (such as a cellular phone), a personal computer, or the like, and prevents important data and files from being broken or stolen.

2. Description of the Related Art

In recent years, miniaturized semiconductor memories having a large storage capacity have been developed, and a cellular phone comprising or incorporating such a semiconductor memory is commercially available. This type of information processing terminal has to be designed in such a manner as to prevent important data from being stolen from the memory.

As an information processing terminal having a data protection function, a terminal comprising both a detachable communication card and a nonvolatile memory card is known in the art. Unless the communication card is detached from the terminal, the memory card cannot be pulled out of the terminal (see Jpn. Pat. Appln. KOKAI Publication No. 2004-362366).

According to the technology shown in this publication, the data in the memory card is automatically deleted when the communication card is detached.

An object of the invention is to provide a terminal apparatus and a data management method which prevent data from being stolen from a memory and which restore the memory to the original state.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory view schematically illustrating a cellular phone to which the invention is applied, as well as a base station for which a server is provided.

FIG. 2 is a block diagram illustrating the cellular phone.

FIG. 3 is a detailed block diagram illustrating the blocks shown in FIG. 2.

FIG. 4 is a flowchart illustrating how authentication processing is performed according to a first embodiment of the invention.

FIG. 5 is a flow chart illustrating how data restoration processing is performed according to the first embodiment of the invention.

FIG. 6 is an explanatory view illustrating according to a second embodiment of the invention.

### DETAILED DESCRIPTION

Various embodiments according to the invention will be described hereinafter with reference to the accompanying drawings. In general, according to one embodiment of the invention, a terminal apparatus comprises a memory, a communication section, an authentication section configured to execute authentication when a signal requesting access to the memory is received, a save processing section configured to save predetermined data of the memory in a predetermined storage section when the authentication section outputs a negative result, and an erasing section configured to erase the predetermined data from the memory after the predetermined data is saved.

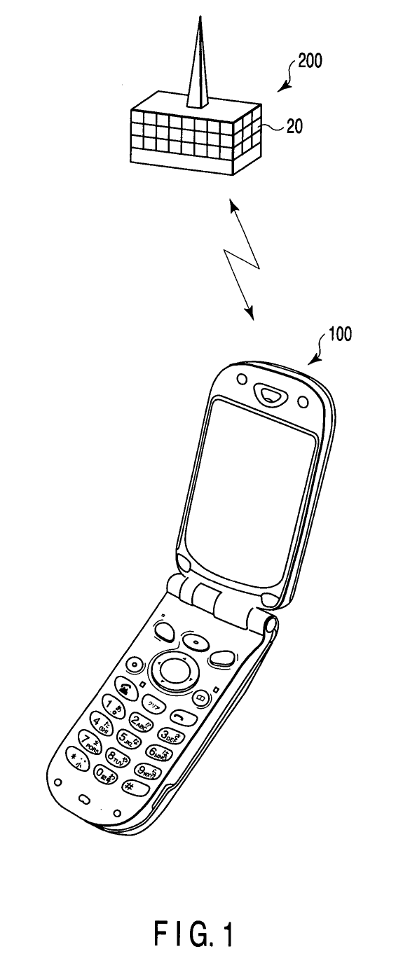

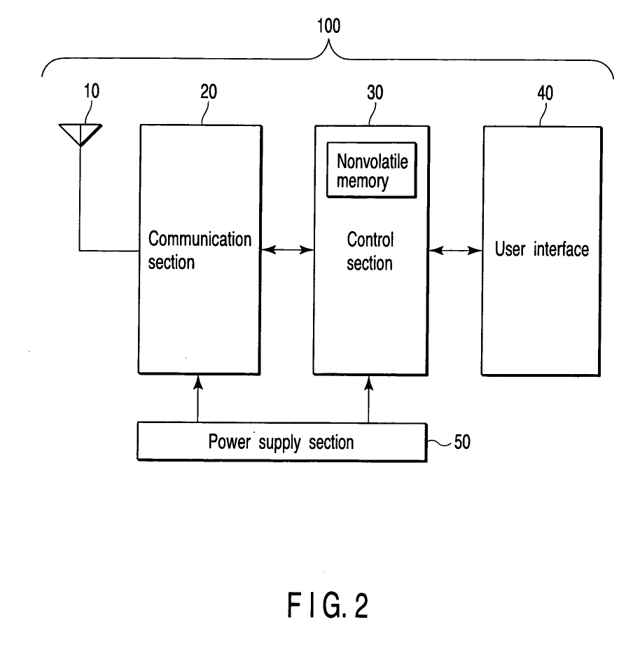

Embodiments of the invention will now be described with reference to the accompanying drawings. FIG. 1 shows a cellular phone 100 to which the invention is applied. FIG. 2 illustrates the internal configuration of the cellular phone 100. Reference numeral 200 in FIG. 1 denotes a base station comprising a server 201.

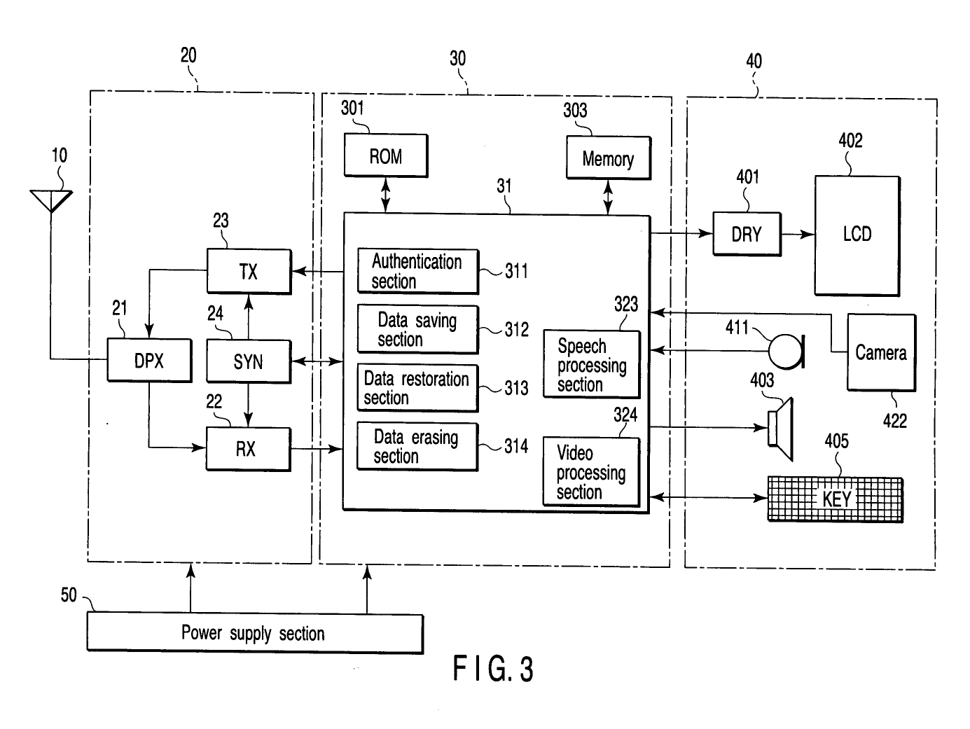

Broadly speaking, the cellular phone 100 includes an antenna 10, a communication section 20, a control section 30 and a user interface 40, as shown in FIG. 2. FIG. 3 illustrates the internal configuration of each of the blocks (structural elements).

Referring to FIG. 3, a radio-frequency signal transmitted from the base station 200 and traveling through a radio channel is received at an antenna 10. After passing through an antenna duplexer (DPX) 21, the radio-frequency signal is supplied to a receiver circuit (RX) 22. The receiver circuit 22 is provided with a high-frequency amplifier, a frequency converter and a demodulator. Inside the receiver circuit 22, the radio signal has its low-frequency noise amplified by a low-frequency noise amplifier. The resultant signal is supplied to the frequency converter, by which it is mixed with a local oscillation signal received from a frequency synthesizer (SYN) 24. As a result, a reception intermediate frequency signal and a reception base band signal are obtained by frequency conversion. The resultant signals (output signals) are supplied to the demodulator, for digital demodulation. Where the cellular phone is a PHS terminal, orthogonal demodulation compatible with the QPSK scheme is used. Where the cellular phone is a CDMA terminal, back diffusion using a spread code is applied to the primary demodulation, and orthogonal demodulation is applied to the secondary demodulation. The local oscillation signal generated by the frequency synthesizer 24 has its frequency controlled by a controller 30.

A demodulated signal output from the demodulator is supplied to the controller 30. This controller 30 includes a base band circuit 31 (which is in the form of an LSI), a ROM 301 and a RAM 303. The base band circuit 31 has a microprocessor (CPU), an error-correcting decoder, a speech encoder/decoder and a video encoder/decoder, etc.

The base band circuit 31 separates the demodulated signal into speech data and video data. The speech data is first subject to error-correcting decoding and is then to speech decoding by the speech encoder/decoder. The video data is first subject to error-correcting decoding, and is then demodulated by the video decoder. The speech signal reproduced by these decoding processes is amplified and output from the speaker 403 of a user interface 40. The video signal is supplied to a liquid crystal display (LCD) 402 by way of the display driver circuit (DRY) 401 of the user interface 40, and is displayed there. The received video data is stored in the RAM 303, as needed.

A speech signal uttered by the user and input to the microphone 411 of an input/output section 3, and a video signal produced by a camera (CAM) 422 at the time of photographing is supplied to the base band circuit 31 of the controller 30. In the base band circuit 31, the speech signal and the video signal are encoded by the speech encoder/decoder and the video encoder/decoder, and the encoded signals are subject to error-correcting encoding. Thereafter, the signals are superposed based on a predetermined format. Transmission data obtained by this superposition is supplied to a transmission circuit (TX) of the communication section 20.

The transmission circuit 23 includes a modulator, a frequency converter and a transmission power amplifier. After being digitally modulated, the transmission data is supplied to the frequency converter. The frequency converter mixes the transmission data with a local oscillation signal generated by the frequency synthesizer 24, so that the transmission data is frequency-converted into a radio frequency signal. Where the cellular phone is a PHS terminal, the QPSK scheme is used. Where the cellular phone is a CDMA terminal, QPSK is applied to the primary modulation, and diffusion modulation using diffusion codes is applied to the secondary modulation. A transmission radio frequency signal, thus generated, is amplified to a predetermined transmission level by the transmission power amplifier. Then, the transmission radio frequency signal is supplied to the antenna 10 through the antenna duplexer 21. The transmission radio frequency signal is transmitted from the antenna 11 to the base station 200.

A power supply section 50 includes a battery (such as a lithium ion battery), a charging circuit for charging the battery, and a voltage generating circuit (PS). The voltage generating circuit is, for example, a DC/DC converter, and generates a predetermined power supply voltage Vcc based on the output voltage of the battery.

The microphone 411 and speaker 403 (which jointly constitute a handset), the liquid crystal display 402, and the camera 422 are structural components of the user interface 40. In addition to these, the user interface 40 comprises a key input section (KEY) 405 and a sounder (not shown). The key input section 405 has a dial key and various types of function keys, and the function keys include an off-hook key, an on-hook key and a search key.

The microprocessor of the controller 30 functions as an authentication section 311, a data saving section 312, a data restoration section 313, and a data erasing section 314. The microprocessor also serves as a speech processing section 323 and a video processing section 324.

The speech processing section 323 adjusts the volume of a received speech signal. The video processing section 324 supplies received video data to the liquid crystal display 402 by way of the display driver circuit 401. Image data photographed or acquired by the camera 422 may be compressed before it is stored in a memory or it is transmitted.

The authentication section 311 performs authentication processing to determine whether a request for accessing the RAM 303 is allowed. When the authentication section 311 determines that the access request is not allowed, the data saving section 312 sends predetermined data in the RAM 303 to a predetermined storage area of an external server, for example. Instead of the external server, the predetermined storage area may be prepared as a sub-memory. After the predetermined data is sent and saved, the data erasing section 314 erases the data in the RAM 303. The data restoration section 313 reads the predetermined data from the server through the use of the communication section 20 and writes the read data in the RAM 303.

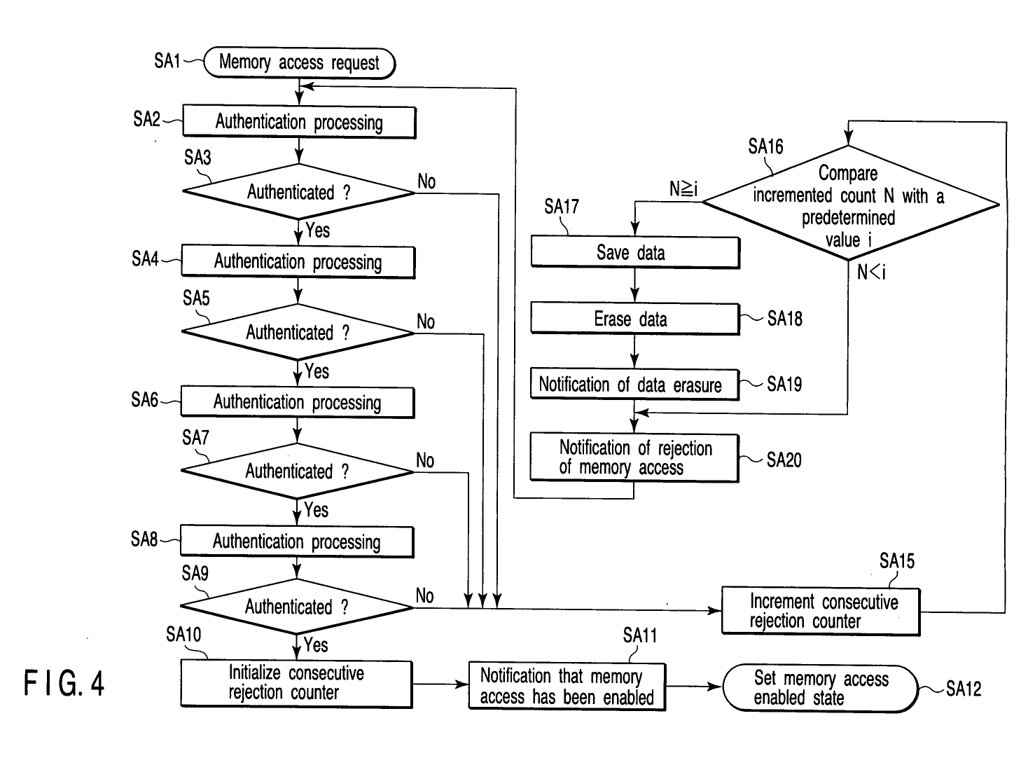

FIG. 4 is a flowchart illustrating the operation performed when a command for requesting the memory access is sensed. It should be noted that the memory access command is not necessarily entered through the communication section 20. It may be entered by operating the key input section 405. The memory access command may be entered in this way if the cellular phone is stolen, for example.

Upon detection of the memory access request (step SA1), the authentication section 311 starts authentication processing. This authentication processing is performed in a number of steps. To be more specific, authentication processing is performed in step SA2, and a result of this authentication processing is determined in step SA3. If the first-time authentication processing ends in success, another authentication processing is performed in step SA4, and a result of this authentication processing is determined in step SA5. If the second-time authentication processing ends in success, still another authentication processing is performed in step SA6, and a result of this authentication processing is determined in step SA7. If the third-time authentication processing ends in success, still another authentication processing is performed in step SA8, and a result of this authentication processing is determined in step SA9.

When all authentication processing ends in success, a consecutive rejection counter is initialized (step SA10), the access requester is notified that the memory access is enabled (step SA11), and a memory access enabled state is set (step SA12).

If the memory access request is not authenticated in step SA3, SA5, SA7 or SA9, the count of the consecutive rejection counter is incremented in step SA15, and the incremented count N is compared with a predetermined value i in step SA 16. Where N<i, the access requester and the display 402 are notified that the memory access has been rejected (Step SA20), and the control flow returns to step SA2. The notification is supplied to the video processing section 324 and the speech processing section 323, so that the display 402 displays an image and the speaker 403 outputs warning sound.

When N becomes greater than i (N≧i) in step SA16, the data in the memory is saved (step SA17) and then the data in the memory is erased (step SA18). In addition, notification of the data erasure is performed. To be more specific, a message indicating the data erasure is shown on the liquid crystal display 402 so that the user can see the data erasure. Thereafter, the access requester and the display 402 are notified that the memory access has been rejected (step SA20).

The above-mentioned data erasure may be automatically performed in the cellular phone. Alternatively, it may be performed when the cellular phone receives a response signal from a server, indicating that the data has been successfully saved. In addition, the server may be so designed as to issue a data deletion command in response to receipt of data and supply the command to the cellular phone from which the data is received.

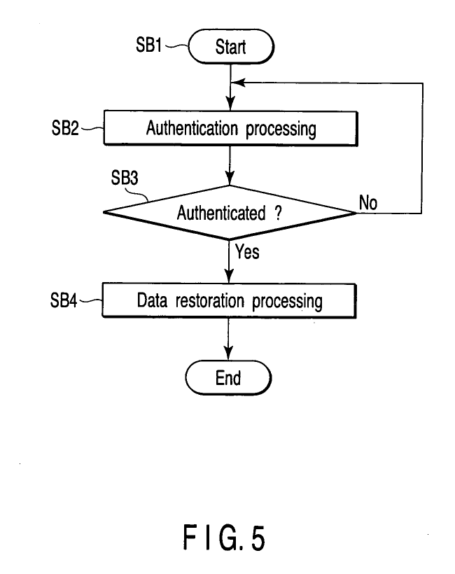

FIG. 5 is a flowchart illustrating how the terminal restores the data saved in the server described above. First of all, the terminal accesses a predetermined server. To be specific, the terminal calls the server based on its telephone number or address, and sends an authentication code to the server, for data restoration (steps SB1, SB2 and SB3). Needles to say, this authentication code is different from the code used when the memory access is requested. After the terminal is authenticated (step SB3), the server sends data to the terminal. The terminal stores the data in its memory (step SB4).

In the process described above, important information stored in the memory 303 (such as information on individuals) is not stolen by hacking.

The above description was given, referring to the measures that are taken to prevent information on individuals from being stolen when a cellular phone is used. However, this description in no way restricts the invention. For example, the invention is applicable to the case where the terminal is a personal computer.

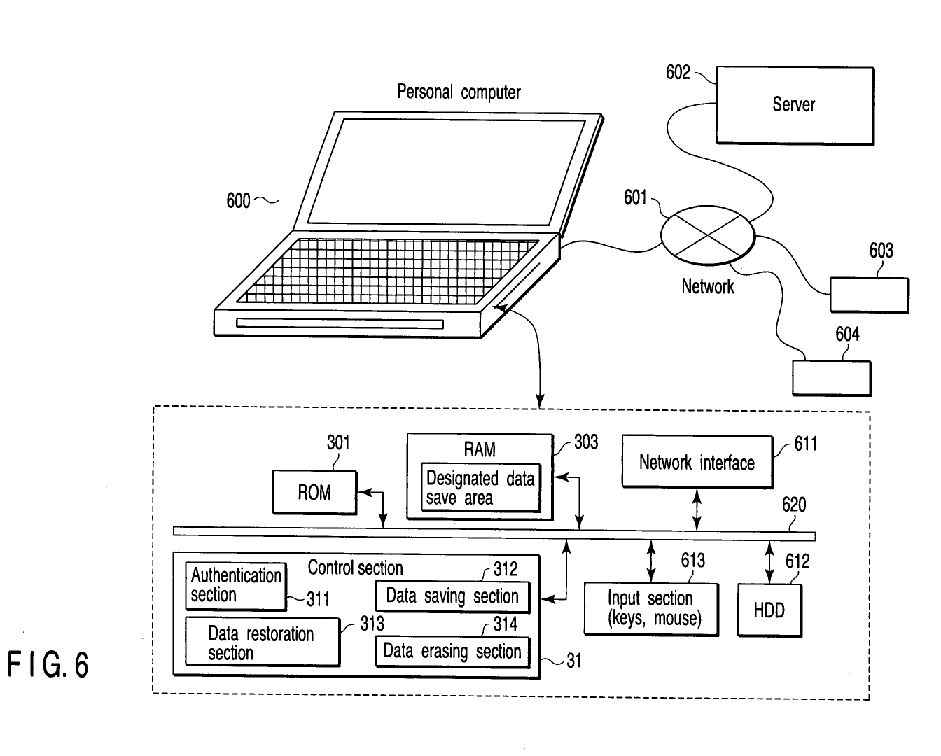

FIG. 6 shows another embodiment of the invention. In FIG. 6, reference numeral 600 denotes a personal computer. The personal computer 600 can communicate with a server 602 by way of a network 601. Other servers or computers 603 and 604 are connected to the network 601.

The personal computer 600 is provided with a bus 620. A controller 31, ROM 301 and RAM 303 are connected to this bus. A network interface 611 and an input section 613, which receives operation inputs from a keyboard and a mouse, are also connected to the bus 620. Furthermore, a hard disk drive 612 is connected to the bus 620.

As in the cellular phone described in connection with the first embodiment, the controller 31 includes an authentication section 311, a data saving section 312, a data restoration section 313, and a data erasing section 314. These sections operate in a similar manner to that described with reference to FIGS. 4 and 5.

RAM 303 includes an area used for specifying data to be saved. When data to be saved is specified in this area, it is stored in the area or a file name corresponding to it is described in the area. When authorized access is detected, the data or file to be saved is automatically stored in the predetermined address area of the server.

As can be seen from the foregoing, important data is prevented from being stolen from the memory. In addition, predetermined data can be restored by reading it from a storage section in which it is saved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A terminal apparatus comprising:
a memory;
a communication section;
an authentication section configured to execute authentication when a signal requesting access to the memory is received;
a save processing section configured to save predetermined data of the memory in a predetermined storage section when the authentication section outputs a negative result; and
an erasing section configured to erase the predetermined data from the memory after the predetermined data is saved.

2. The terminal apparatus according to claim 1, wherein the erasing section automatically erases the predetermined data from the memory after the save processing section saves the predetermined data.

3. The terminal apparatus according to claim 1, wherein the erasing section erases the predetermined data from the memory after the save processing section saves the predetermined data and when the predetermined storage section outputs a message indicating that the predetermined data has been saved.

4. The terminal apparatus according to claim 1, wherein the erasing section erases the predetermined data from the memory after the save processing section saves the predetermined data and when the predetermined storage section supplies a data erasing command to the erasing section.

5. The terminal apparatus according to claim 1, wherein the save processing section saves the predetermined data in a remote server by sending the predetermined data by way of the communication section.

6. The terminal apparatus according to claim 1, wherein the save processing section saves the predetermined data in a specified memory.

7. The terminal apparatus according to claim 1, further comprising:
a data restoration section configured to read out the predetermined data from the predetermined storage section and store the predetermined data back into the memory.

8. The terminal apparatus according to claim 1, further comprising:
a speech processing section;
an image output section; and
a display device,
wherein when the authentication section outputs the negative result, a warning signal is issued based on sound output and/or image display.

9. A data management method which uses a memory, a communication section and a control section and which manages data in the memory under control of the control section, said data management method comprising:
executing authentication upon receipt of a signal requesting access to the memory;
saving predetermined data of the memory in a predetermined storage section when the authentication produces a negative result; and
erasing the predetermined data from the memory after the predetermined data is saved.

10. The data management method according to claim 9, wherein the predetermined data is erased from the memory automatically after the predetermined data is saved.

11. The data management method according to claim 9, wherein the predetermined data is erased from the memory after the predetermined data is saved and when a message indicating that the predetermined data has been saved is output.

12. The data management method according to claim 9, wherein the predetermined data is erased from the memory after the predetermined data is saved and when a data erasing command is supplied from the predetermined storage section.

13. The data management method according to claim 9, wherein the predetermined data is saved in a remote server after being sent to the predetermined storage section by way of the communication section.

14. The data management method according to claim 9, wherein the predetermined data is saved in a specified memory.

15. The data management method according to claim 9, further comprising:
reading out the predetermined data from the predetermined storage section and storing the predetermined data back into the memory.

16. The data management method according to claim 9, wherein when the negative result is output, a warning signal is issued based on sound output and/or image display.
